(19) United States
(12) Patent Application Publication
(10) Pub. No.: US 2003/0033127 A1
(43) Pub. Date: Feb. 13, 2003

(54) Automated hypothesis testing

(76) Inventor: Gregory Scott Lett, Hightstown, NJ (US)

Correspondence Address: PHYSIOME SCIENCES, INC., 150 COLLEGE ROAD WEST, PRINCETON, NJ, 08540, US

(21) Appl. No.: 10/238,167

(22) Filed: Sep. 10, 2002

Related U.S. Application Data
(63) Continuation-in-part of application No. 10/095,175, filed on Mar. 11, 2002.
(60) Provisional application No. 60/275,287, filed on Mar. 13, 2001.

(51) Int. Cl. G06G 7/48; G06G 7/58

(52) U.S. Cl. 703/11

(57) ABSTRACT

The present invention relates to a method and system for automatically constructing computer simulation models of biological systems. More specifically, a series of simulation models are created, or selected from a repository of standard models, preferably based on experimental data. These models are then calibrated, if necessary, based upon experimental data and then compared to each other for goodness of fit to a set of experimental data; the best models can then be selected based upon the goodness-of-fit calculations. Another aspect of the invention provides for automated design of additional experiments to differentiate between models that have the same or similar goodness-of-fit scores.

### CROSS-REFERENCE TO RELATED APPLICATION

This application is a continuation-in-part of U.S. patent application Ser. No. 10/095,175, filed on Mar. 11, 2002, which claims priority from provisional U.S. patent application Ser. No. 60/275,287, filed on Mar. 13, 2001, both of which are incorporated herein by reference.

### BACKGROUND OF THE INVENTION

1. Field of the Invention

The present invention relates to a method and system for automatically constructing computer simulation models of biological systems.

2. Description of the Related Art

Recently, there have been significant advances in the development of highly detailed computer-implemented simulations of biological or physiological systems. These models can be used, for example, to describe and predict the temporal evolution of various biochemical, biophysical and/or physiological variables of interest. These simulation models have great value both for pedagogical purposes (i.e., by contributing to our understanding of the biological systems being simulated) and for drug discovery efforts (i.e., by allowing in silico experiments to be conducted prior to actual in vitro or in vivo experiments).

However, existing methods for building such computer simulation models in biology are labor-intensive and error-prone. The effort required to build and validate a complex biological model may involve tens or hundreds of person-years. The process for constructing reliable simulation models requires analyzing experimental data and documents, generating hypotheses in the form of mathematical formulae that can be simulated using a computer, and then testing the hypotheses by comparing the predictions of simulation models to experimental data. Once validated, these simulation models can be used to great benefit in a number of areas, including pharmaceuticals, medical devices and public health.

The numerous types of biological simulation models range from organ models, such as the computational model for simulating the electrical and chemical dynamics of the heart that is described in U.S. Pat. No. 5,947,899 (Computational System and Method for Modeling the Heart), which is hereby incorporated by reference, to cell simulation models such as the one described in U.S. Pat. No. 6,219,440 (Method and Apparatus for Modeling Cellular Structure and Function), which is hereby incorporated by reference. Pathway models are another broad class of models that are useful for modeling certain biological systems and for understanding certain biological phenomena. Examples of software capable of pathway modeling include the biological modeling platform by Physiome Sciences, Inc. (Princeton, N.J.), which is described in U.S. patent application Ser. No. 09/295,503 (System and Method for Modeling Genetic, Biochemical, Biophysical and Anatomical Information: In Silico Cell); Ser. No. 09/499,575 (System and Method for Modeling Genetic, Biochemical, Biophysical and Anatomical Information: In Silico Cell); Ser. No. 09/599,128 (Computational System and Method for Modeling Protein Expression); and Ser. No. 09/723,410 (System for Modeling Biological Pathways), which are each hereby incorporated by reference. Other approaches to biological simulation are described in U.S. Pat. No. 5,980,096 (Computer-Based System, Methods and Graphical Interface for Information Storage, Modeling and Stimulation of Complex Systems); U.S. Pat. No. 5,930,154 (Computer-Based System and Methods for Information Storage, Modeling and Simulation of Complex Systems Organized in Time and Space); U.S. Pat. No. 5,808,918 (Hierarchical Biological Modelling System and Method); and U.S. Pat. No. 5,657,255 (Hierarchical Biological Modelling System and Method), which are each hereby incorporated by reference.

Examples of existing biological simulation software include: (1) DBsolve, which is described in further detail in I. Goryanin et al., “Mathematical Simulation and Analysis of Cellular Metabolism and Regulation,” Bioinformatics 15(9): 749-58 (1999); (2) GEPASI, which is described in further detail in a number of publications, including P. Mendes & D. Kell, “Non-Linear Optimization Of Biochemical Pathways: Applications to Metabolic Engineering and Parameter Estimation,” Bioinformatics 14(10): 869-83 (1998); P. Mendes, “Biochemistry By Numbers: Simulation of Biochemical Pathways with GEPASI 3,” Trends Biochem. Sci. 22(9): 361-63 (1997); P. Mendes & D. B. Kell, “On the Analysis of the Inverse Problem of Metabolic Pathways Using Artificial Neural Networks,” Biosystems 38(1): 15-28 (1996); P. Mendes, “GEPASI: A Software Package for Modeling the Dynamics, Steady States and Control of Biochemical and Other Systems,” Comput. Appl. Biosci. 9(5): 563-71 (1993); (3) NEURON, which is described in more detail in M. Hines, “NEURON: A Program for Simulation of Nerve Equations,” Neural Systems: Analysis and Modeling (F. Eeckman, ed., Kluwer Academic Publishers, 1993); and (4) GENESIS, which is described in detail in J. M. Bower & D. Beeman, The Book of GENESIS: Exploring Realistic Neural Models with the General Neural Simulation System, (2d ed., Springer-Verlag, New York, 1998). The selection of the appropriate simulation software and/or simulation model will depend upon the nature of the biological system of interest, the types of data available, and the nature of the problem to be solved. While the choice of an appropriate model is often complex, it is within the skill of the ordinary artisan to identify suitable models based upon the aforementioned factors.

Notably, the technology and techniques for generating and validating new computer simulation models has not kept pace with advances in biological experimental methods—in particular, with the development of high-throughput assays and other experimental techniques. In short, the technology for generating data has far outstripped the technology for helping scientists understand the new information contained in the data. New technologies, such as gene microarrays and automated cell imaging techniques have created an explosion of data that is difficult to interpret. The number of variables being measured and the sheer quantity of data generated can make manual analysis impossible or at least impractical.

For example, microarray technologies exist that can measure the expression levels of tens of thousands of genes simultaneously, and multiple arrays can track the changes of those expression levels over time and under different conditions. The biological systems being observed in the laboratory experiments are highly variable, and there are a number of sources of uncertainty in the data, making interpretation difficult or impossible. A large number of analytical and visualization techniques for reducing the uncertainty and complexity of the data have been recently developed. Examples of new analysis techniques include cluster analysis, see, e.g., M. B. Eisen et al., “Cluster Analysis and Display of Genome-Wide Expression Patterns,” Proc. Nat'l Acad. Sci. 95(25): 14863-68 (1998), and Bayesian network analysis, see, e.g., K. Sachs et al., “Bayesian Network Approach to Cell Signaling Pathway Modeling,” Sciences's STKE (2002), http://stke.sciencmag.org/cgi/content/full/sig-trans; 2002/148/pe38.

Many of these existing methods work by estimating statistics based on the data to identify those measurements or variables that are significant by some measure. The measure of significance may be based on the magnitude of the change from a control or expected result, or based upon a pattern of similar behavior across measurements. The measure of statistical significance helps to reduce both the amount of data as well as the uncertainty in the measured values.

Visualization techniques can also help to reduce the complexity of the data further by using the ability of humans to recognize patterns in a graphical representation. By comparing the visual representation of data with visual patterns already known, scientists are assisted in their search for information that is new. This provides clues for investigation, which eventually lead to new hypotheses that can be tested in the laboratory. Simulation models can be considered as one form of hypothesis that can be tested in the laboratory, if they yield predictions about the outcomes of those experiments. Unfortunately, current technology for reducing the data still results in more clues than can be interpreted by human scientists, unless the criteria for significance is so high that important information in the data is lost.

A popular approach to modeling high-volume data in the biological sciences is to infer qualitative relationships from high throughput data. A common pattern in many of these methods is the generation of a network representing biological entities and statistical relationships between the entities. Examples of such approaches include Boolean networks, Bayesian networks and regression trees.

Existing techniques for developing computer simulation models of biological systems, such as those described above, suffer from various drawbacks. Most significantly, these techniques typically require human expertise and judgment to sift through large quantities of data and to identify patterns within such data in order to select or develop the appropriate simulation model. For example, a Boolean network or a Bayesian network may be able to reconstruct a network of likely interactions from microarray data, but with current technology, painstaking effort is required to generate and test hypotheses about what the interaction might be (e.g., a kinase interacts with a protein by catalyzing the phosphorylation of the protein in a series of biochemical reactions). A scientist may have to consider this and other possible interpretations of interacting species to map from a Boolean network to a reaction network by trial-and-error scientific investigation. Such a labor-intensive approach is costly and time-consuming, and incompatible with the newly developed high-throughput experimental methods.

What is needed therefore are methods and systems for automatically generating hypothetical simulation models of biological systems and identifying the models that best describe the observed experimental data for the biological system at issue. In addition, also needed are automated methods for generating experiments and experimental protocols for distinguishing between simulation models that are equally likely to describe an existing data set.

### SUMMARY OF THE INVENTION

There is provided a method and system for automatically generating hypothetical simulation models and selecting the most likely model based upon a set of experimental, said system comprising: a hypothesis generation system for generating a hypothetical simulation model; a parameter estimation system for estimating the parameters for said hypothetical simulation model; and a model-scoring system for evaluating the likelihood that a particular model describes the biological system of interest. In one embodiment of the invention, the hypothesis generation system selects a set of simulation models for evaluation based upon experimental data stored in a data repository. The hypothesis generation system may include a knowledge-based or rule-based system for selecting and evaluating simulation models. In a preferred embodiment, the hypothesis generation system can modify or alter (in addition to selecting) standard models stored in the model repository.

In a preferred embodiment, the parameter estimation system calibrates the simulation model generated by the hypothesis generation system using experimental data stored in a data repository and information from an experimental protocol repository about the experimental protocols used to generate the data. Preferably, the model scoring system ranks the calibrated models generated by the parameter estimation system based upon experimental data stored in the data repository, as well as information stored in the experimental protocol repository.

Optionally, an experimental design system/module can automatically generate designs of additional experiments to further discriminate between the top-ranked validated models. Performing the experiments suggested by the experimental design system will generate new data, which can be used to generate new hypothetical simulation models, re-estimate parameters and/or rescore/rerank the calibrated models. Preferably, the experimental data gathering system is itself also automated.

Further objects, features, aspects and advantages of the present invention will become apparent from the drawings and description contained herein.

### BRIEF DESCRIPTION OF THE DRAWINGS

The invention will be more fully understood and further advantages will become apparent when reference is made to the following detailed description and the accompanying drawing(s) in which:

FIG. 1 is a diagram depicting some of the components of one embodiment of the invention.

### DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

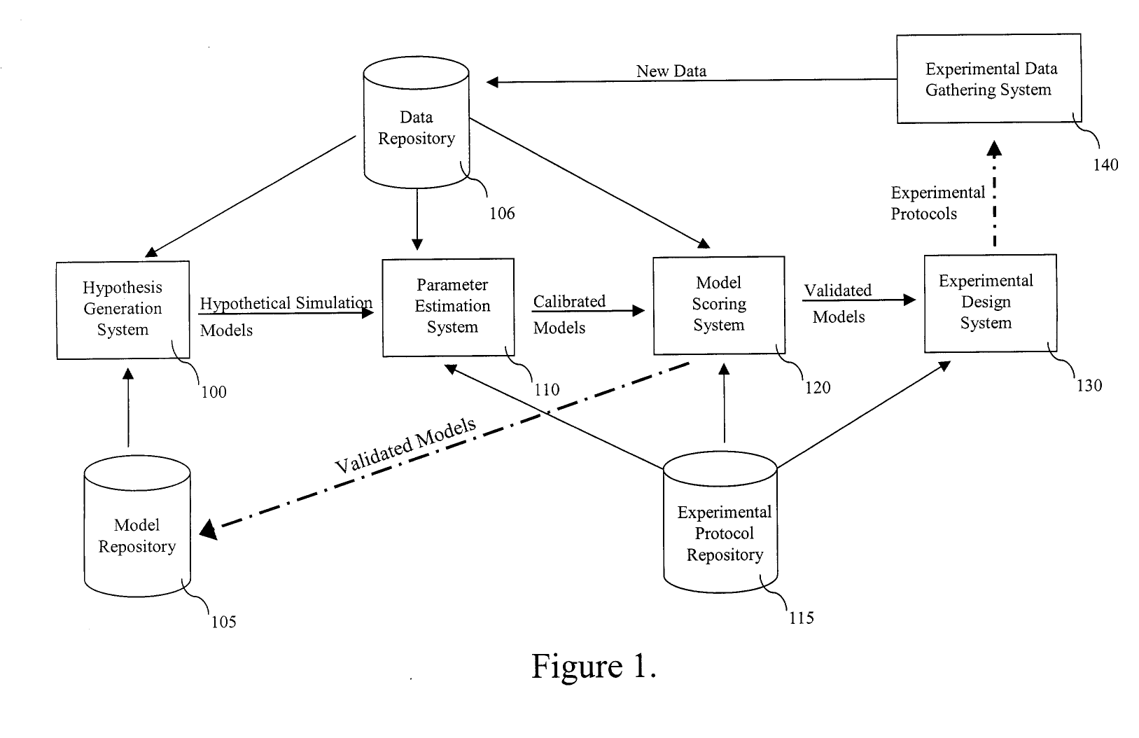

As shown in FIG. 1, the hypothesis generation system 100 generates a plurality of hypothetical simulation models intended to describe a particular biological or physiological system. The hypothesis generation system 100 may select a set of simulation models stored in a model repository 105 based upon experimental data stored in a data repository 106, user input or a combination thereof. In one embodiment, the hypothesis generation engine 100 may modify or augment a selected “standard” model based upon user input, experimental data or a combination thereof. In another embodiment, the hypothesis generation engine 100 is capable of creating simulation models ab initio based upon experimental data.

These simulation models are then passed to the parameter estimation system 110, which calibrates these models based upon experimental data stored in the data repository 106. The calibration is accomplished by adjusting the various adjustable parameters of the model to provide the closest fit to the observed data (i.e., to minimize some error measure). The data set used to calibrate the model may or may not be the same data set used to select and/or create the model. In some cases, the calibration takes into account information about the experimental protocol used to obtain the data used for the calibration; this information is stored in an experimental protocol repository 115. It is possible that some models do not have any adjustable parameters or otherwise do not have to be calibrated (e.g., the particular model being passed was previously calibrated using the same data set). In that case, the parameter estimation system 110 performs the trivial task of passing on the identical simulation model that it received from the hypothesis generation system 100.

The calibrated models are then evaluated by the model scoring system 120 for closeness of fit to the experimental data, which is stored in the data repository 106. The model scoring system may also take into account information about the experimental protocol used to generate the experimental data used for the scoring. This information may be the same as or different from the experimental-protocol information used by the parameter estimation system 110.

Preferably, the model scoring is performed using a different subset of data than that used to calibrate the model or to select the model in the first place. Preferably, the model scoring system 120 includes a penalty for model complexity (such that all else being equal, the model having greater degrees of freedom—i.e., fewer variables—is scored as the better model). Based on the calculated score, the model scoring system 120 identifies to the user one or more “best” models. Optionally, these validated models may then be stored in the model repository 105.

In some cases, based on the existing data, two or more calibrated models may have the same or very similar scores, and hence may be statistically indistinguishable in terms of “goodness of fit” to the data. In such cases, it would be valuable to perform additional experiments to determine which of the statistically equivalent models is actually superior. Accordingly, another aspect of the invention provides for an experimental design system 130 that automatically generates one or more recommended experiments to be performed to help distinguish between the “equally good” validated models generated by the model scoring system 120. The experimental design system 130 designs such an experiment or experiments by examining the differences between the validated models. In addition, the experimental design system 130 may use information stored in the experimental protocol repository 115 to help design an appropriate protocol.

Next, the proposed experiments may be carried out manually or using automated equipment—as represented by the experimental data gathering system 140. Indeed, through the use of robots and other automated machinery directed by a computer, no human intervention at all may be necessary. The new data collected by the experimental data gathering system may then be used by the model scoring system 120 to re-rank the calibrated models. Alternatively, the models may first be recalibrated by the parameter estimation system 110 using the new data (or some subset of the new data). Yet another alternative would be for the hypothesis generation system 100 to generate new hypothetical simulation models using a dataset that includes the new data, and have those new hypothetical simulation models be sent to the parameter estimation system 110 and then to the model scoring system 120 again. This cycle can be repeated again if the model scoring system is still not able to discern which of more than one validated model is superior.

The various components of the invention are described in more detail below.

Data, Model and Experimental Protocol Repositories

The data repository is any device, apparatus, structure or means for storing experimental data. Most typically, experimental data will be stored in a standard relational database format and can be retrieved or manipulated using standard database queries/tools. However, the data can also be stored in a flat file format or a hierarchical format. The various datasets used in the above-described process can be stored in a single repository or separate repositories. The choice of the appropriate database format and architecture will depend upon factors such as the type of data being used, the size of the database, and the need to share data across a network. However, one skilled in the art will readily be able to make such a choice.

Similarly, the model repository is any device, apparatus, structure or means for storing computer simulation models. Again, any of a number of possible database formats and architecture may be used. Preferably, the models will be stored in an XML format such as CellML or SBML.

Finally, the experimental protocol repository is also any device, apparatus, structure or means for storing experimental protocols and information concerning such protocols. Again, any of a number of possible database formats and architecture may be used.

Hypothesis Generation System

A very simplistic hypothesis generation system can be implemented by simply passing all of the simulation models stored in the model repository to the parameter estimation system. Alternatively, the hypothesis generation system could select a subset of the simulation models based on user input (e.g., select only models of a certain type/class, eliminate all models of a certain type/class). A more sophisticated hypothesis generation system could automatically eliminate certain models based upon the experimental data or patterns detected in the data. Moreover, the hypothesis generation system could include algorithms for modifying the selected models based upon the experimental data.

One approach to model selection and/or modification would be to use an expert system or rule-based approach. Alternatively, machine learning algorithms may be employed to select and/or modify models.

Finally, the hypothesis generation system may generate the model ab initio based on the experimental data. For example, techniques exist for creating pathway maps based upon gene array data or based upon assays for protein-protein interactions. Recently, various automated methods have been developed to generate pathway maps without human direction, judgment or input. See, e.g. B. E. Shapiro et al., “Automatic Model Generation for Signal Transduction with Applications to MAP-Kinase Pathways,” in Foundations of Systems Biology (H. Kitano, ed., MIT Press, 2002). Although the maps or models generated by such techniques currently tend to be unreliable and inaccurate, they may be used to create initial “first cut” models, which may be pruned, modified and calibrated in accordance with the teachings of this application to produce higher fidelity models.

The simulation models may be of various forms and formats. Indeed, the simulation model need not be a strictly quantitative model; it is possible to apply the claimed invention to qualitative or semi-quantitative models so long as it is possible to evaluate the performance of one model vis-à-vis another (e.g., using non-parametric statistics). Preferably, however, the simulation model for a particular biological or physiological system would comprise a set of coupled ordinary differential equations (ODEs) or partial differential equations (PDEs), which describe the spatiotemporal evolution of the variables governing the system in question, as well as the relationship between these variables. In certain cases, the system being modeled may be simple enough to be modeled by a system of coupled algebraic equations.

Parameter Estimation System

Numerous methods for calibrating a simulation model exist. Many of these methods are described in detail in U.S. patent application Ser. No. 10/095,175 (Biological Modeling Utilizing Image Data), which is hereby incorporated by reference. Whether referred to as model calibration or parameter estimation, the objective is to set the adjustable parameters of a model so as to minimize some error measure quantifying the difference between the predicted values of the model and the observed experimental values of those variables.

One may explicitly calculate an error measure (such as the sum of the squares of the differences between the predicted and experimentally observed value of a variable), and then adjust the simulation model parameters systematically until the error measure is minimized or reduced; alternatively, one may use a calibration method that inherently minimizes or reduces some error measure (without explicitly computing the error measure). The most simplistic (and most computationally intensive) approach consists of trying every combination of values for every adjustable parameter. For any reasonably complex model, however, such an approach would be impractical.

A preferred method for adjusting the model comprises applying a batch estimator or recursive filter, as described more fully below. Numerous batch estimators and recursive filters are well known in the art. Examples of batch estimators include the Levenberg-Marquardt method, the Nelder-Mead method, the steepest descent method, Newton's method, and the inverse Hessian method. Examples of recursive filters include the least-squares filter, the pseudo-inverse filter, the square-root filter, the Kalman filter and Jazwinski's adaptive filter. Preferred for applications wherein random events during an experiment perturb the state and the subsequent course of the experiment in a significant way are fading-memory filters, such as the Kalman filter, which remain sensitive to new data. Most preferred for certain applications are extensions/variants of the Kalman filter, such as the Extended Kalman Filter (EKF), the unscented Kalman Filter (UKF) and Jazwinski's adaptive filter (as described more fully in A. H. Jazwinski, Stochastic Processes And Filtering Theory (Academic Press, New York, 1970)); these filters can combine computational efficiency, robustness and the fading-memory characteristics discussed above. When the actual error distributions do not fit the assumptions underlying these filters, other estimators, such as the Particle Filter (PF) and other sequential Monte Carlo estimators can be used.

Another approach to model calibration includes the use of a neural network model for adjusting the parameters of the simulation model and/or modifying the structural features of the simulation model used to predict the spatiotemporal evolution of the biological or physiological system. For example, a standard multi-layer perceptron (MLP) neural network may be applied to the time-series data. Preferably, however, a recurrent neural network (RNN) model, which is better suited to detection of temporal patterns, would be used. In particular, the Elman neural network is a RNN architecture that may be well suited for noisy time series. See J. L. Elman, “Distributed Representations, Simple Recurrent Networks, and Grammatical Structure,” Machine Learning 7(2/3): 195-226 (1991).

Hybrid neural network algorithms may also be applied. For example, prior to the grammatical inference step (i.e., using a neural network to predict the evolution of the time series), one may use a self-organizing map (SOM) to convert the time series data into a sequence of symbols. A self-organizing map is an unsupervised learning process, which “learns” the distribution of a set of patterns without any class information. A pattern is projected from a (usually) high-dimensional input space to a position in a low-dimensional display space. The display space is typically divided into a grid, and each intersection of the grid is represented in the network by a neuron. Unlike other clustering techniques, the SOM attempts to preserve the topological ordering of the classes in the input space in the resulting display space. See T. Kohonen, Self-Organizing Maps (Springer-Verlag, Berlin, 1995). Symbolic encoding using a SOM makes training the neural network easier, and aids in the extraction of symbolic knowledge.

Model Scoring System

The model scoring system component compares simulation models by assessing the “goodness of fit” of a model to experimentally observed results. This component allows a scientist to evaluate a large number of automatically generated hypotheses or models by filtering out those that do not “match” experimental results. The basic inputs to the model scoring system are measurements predicted by these models and the actual clinical, field or laboratory measurements corresponding to the predicted measurements. A straightforward approach is to calculate the weighted sum of the magnitude (or alternatively the square) of the residuals (i.e., the differences between the predicted and actual measurements). This calculated error measure can be viewed as an estimate of the predictive ability of the model in question. Various models can then be compared or ranked based upon their respective error measures.

In addition to ranking models based upon “goodness of fit,” it would be useful to determine whether one model is statistically “superior” to another model in terms of explaining the observed data. That is, a scientist would want to know whether a more highly ranked model is truly superior in a statistical sense.

One approach to making this determination is to perform a so-called hypothesis test by treating the current “best model” as the null hypothesis (i.e., represents the theory being tested) and the new model as the alternative hypothesis. After choosing an appropriate test statistic and level of significance, one may then determine whether or not the null hypothesis should be rejected in favor of the alternative hypothesis. Hence, the model scoring system could then create a partial ordering of models based upon a “quality” measure and thereby be used to filter out poor hypotheses (i.e., models). For this reason, the model scoring system component can also be viewed as an “automatic hypothesis testing component.”

Various test statistics and goodness-of-fit tests are described in the literature. See, e.g. W. J. Conover, Practical Nonparametric Statistics (2nd ed., John Wiley & Sons, New York, 1980); R. B. D'Agostino & M. A. Stephens, Goodness-of-Fit Techniques (Dekker, New York, 1986); W. W. Daniel, Biostatistics (6th ed., John Wiley & Sons, New York, 1995). The skilled artisan would be capable of selecting an appropriate test statistic or goodness-of-fit test. Generally, goodness-of-fit tests test the conformity of the observed data's empirical distribution function with a posited theoretical distribution function. For example, the chi-square goodness-of-fit test does this by comparing observed and expected frequency counts. The Kolmogorov-Smirnov test does this by calculating the maximum vertical distance between the empirical and posited distribution functions. Another alternative goodness-of-fit test is the Anderson-Darling test.

In using the Chi-square statistic in scoring a model, one is comparing the weighted sum of the squared residuals over all measurements versus the Chi-square statistic with the appropriate degrees of freedom. This gives the probability that the residuals behave like measurement error. An alternative test, such as the Kolmogorov-Smirnov test, compares the distribution of the residuals, rather than their sum, to an expected distribution defined by the measurement errors.

An alternative approach is to compare the variances of the residuals. Tests such as the F test can be used to compare the residuals of two models, rejecting one if the variance of the residuals is significantly larger than those of the other model. There are alternatives to the Kolmogorov-Smirnov test that work better when the errors are not normally distributed, such as the Shapiro-Wilk statistic.

Non-parametric statistical tests also exist when probability distributions are not known. For example, the Mann-Whitney test can be used to compare the residuals of two models. The nonparametric approaches make fewer assumptions about the distribution of the residuals, but in general require more data and work best with simple models.

It should be noted that, in general, models with a greater number of adjustable parameters will appear to “fit” the data better (i.e., residuals will be lower) than models with fewer parameters without necessarily being a better model. For example, two measurements at different times can be fit exactly by a line, but the quality of such a model can be very poor due to noise in the measurements. Thus, it would be desirable to take into account the relative complexity of models and the number of degrees of freedom of particular models when comparing the predictive ability of two models.

One approach would be to use the Akaike Information Criterion. See H. Akaike, “Information Theory and an Extension of the Maximum Likelihood Principle,” in Proc. 2nd Int'l Symp. Info. Theory, pp. 267-81 (B. N. Petrov & F. Csaki, eds., Akademia Kiado, Budapest, 1973). Forster discusses the advantages of using such a criterion as a measure for comparing the predictive ability of models. See M. R. Forster, “The New Science of Simplicity,” in Simplicity, Inference and Modelling, pp. 83-117 (A. Zellner, H. Keuzenkamp & M. McAleer, eds., Cambridge, Cambridge University Press 2001).

Experimental Design System

When designing a new experiment, a scientist is typically trying to test a hypothesis or decide between two competing hypotheses. It is assumed here that the existing experimental data in the database is insufficient to determine which of two or more competing hypotheses is “correct.” In such a situation, one objective in designing a new experiment is to maximize the probability that one will be able to distinguish between the competing hypotheses.

The statistical power is a measure of the probability that a particular experiment and data analysis will correctly reject one model for another, given a particular significance level. (The significance level is chosen by the scientist as part of the criteria for hypothesis testing.) That is, the power of a statistical hypothesis test measures the test's ability to reject the null hypothesis when it is actually false—that is, to make a correct decision. In other words, the power of a hypothesis test is the probability of not committing a so-called “type II” error.

For any given protocol, there is always an adjustable parameter (e.g., the number of repetitions of the experiment) that affect the statistical power. The statistical power of an experiment or set of experiments may be estimated using Monte Carlo techniques or by calculation from the estimates of uncertainties in the parameters and the experimental measurements. By looking at the variation in the outcome of the hypothesis test under a full range of conditions, one can thereby estimate the power of the test. By analyzing each experiment in terms of its adjustable parameters, one may apply optimization techniques to select a set of parameters that maximize the statistical power.

The experimental design system component takes as inputs: the highest ranking validated models outputted by the model scoring system, information about the experimental protocols used to generate the existing data (as well as information about alternative protocols), the existing parameter estimates and the uncertainties of the parameter estimates. The experimental design system then estimates the statistical power of various possible experiments, and then selects an experiment or experiments that will maximize the statistical power of the experiment(s). There are other measures that can be used as objectives for optimization as well, such as minimizing the expected a posteriori uncertainty in the parameters of the model, etc. Any one of a number approaches can be used to implement the experimental design system without departing from the spirit of the invention as long as the proposed experiments would help the scientist to choose between roughly equivalent hypotheses. These approaches are described in the literature relating to industrial experiment design. See, e.g., D. C. Montgomery, Design and Analysis of Experiments (5th ed. 2000).

The foregoing descriptions of specific embodiments of the present invention are presented for purposes of illustration and description. They are not intended to be exhaustive or to limit the invention to the precise forms disclosed; indeed, many modifications and variations are possible in view of the above teachings. The embodiments were chosen and described in order to explain the principles of the invention and its practical applications, and to thereby enable others skilled in the art to utilize the invention in its various embodiments with various modifications as are best suited to the particular use contemplated. Therefore, while the invention has been described with reference to specific embodiments, the description is illustrative of the invention and is not to be construed as limiting the invention. In fact, various modifications and amplifications may occur to those skilled in the art without departing from the true spirit and scope of the invention as defined by the subjoined claims.

All publications, patents and patent applications mentioned in this specification are herein incorporated by reference to the same extent as if each individual publication or patent application were specifically and individually designated as having been incorporated by reference.

What is claimed is:

1. A method for automated hypothesis testing, said method comprising the steps of:
a. generating or selecting a plurality of computer simulation models of a biological or physiological system;
b. calibrating said plurality of models;
c. comparing or ranking said plurality of models based upon the goodness of fit of each model to experimental data; and
d. designing at least one experiment to help differentiate between two or more statistically equivalent models.

2. The method of claim 1 further comprising the step of performing said experiment designed in step d.

3. The method of claim 1 further comprising the step of modifying at least one of the plurality of models generated or selected in step a.

4. The method of claim 1 wherein the step of generating or selecting said plurality of models includes use of an expert system or machine learning algorithm.

5. The method of claim 1 wherein said calibration step is based at least in part on information about the experimental protocols used to generate the experimental data used in the calibration step or any earlier steps.

6. The method of claim 1 wherein said calibration step uses a batch estimator or recursive filter.

7. The method of claim 6 wherein said batch estimator is selected from the group consisting of the Levenberg-Marquardt method, the Nelder-Mead method, the steepest descent method, Newton's method, and the inverse Hessian method.

8. The method of claim 6 wherein said recursive filter is selected from the group consisting of the least-squares filter, the pseudo-inverse filter, the square-root filter, the Kalman filter and Jazwinski's adaptive filter.

9. The method of claim 1 wherein said calibration step uses a neural network algorithm, a hybrid neural network algorithm or self-organizing map.

10. The method of claim 1 wherein said comparison or ranking step uses a subset of data not used in said calibration step.

11. The method of claim 1 wherein said comparison or ranking step includes a penalty for model complexity.

12. The method of claim 1 wherein said comparison or ranking step uses the Chi-square test, the Kolmogorov-Smirnoff test or the Anderson-Darling test.

13. The method of claim 1 wherein said comparison or ranking step uses the Akaike Information Criterion.

14. The method of claim 1 wherein said comparison or ranking step uses a non-parametric statistical test.

15. A system for automated hypothesis testing, said system comprising the steps of:
a. a hypothesis generation system for generating or selecting a plurality of computer simulation models of a biological or physiological system;
b. a parameter estimation system for calibrating said plurality of models;
c. a model scoring system for comparing or ranking said plurality of models based upon the goodness of fit of each model to experimental data; and
d. an experimental design system for designing at least one experiment to help differentiate between two or more statistically equivalent models.

16. The system of claim 15 further comprising an experimental data gathering system for performing the experiment designed by said experimental design system.

17. The system of claim 15 wherein said hypothesis generation system modifies at least one of said plurality of models generated or selected by said hypothesis generation system.

18. The system of claim 15 wherein said hypothesis generation system uses an expert system or machine learning algorithm.

19. The system of claim 15 wherein said parameter estimation system utilizes information about the experimental protocols used to generate the experimental data used in the calibration step or any earlier steps.

20. The method of claim 15 wherein said parameter estimation system uses a batch estimator or recursive filter.

21. The method of claim 20 wherein said batch estimator is selected from the group consisting of the Levenberg-Marquardt method, the Nelder-Mead method, the steepest descent method, Newton's method, and the inverse Hessian method.

22. The method of claim 20 wherein said recursive filter is selected from the group consisting of the least-squares filter, the pseudo-inverse filter, the square-root filter, the Kalman filter and Jazwinski's adaptive filter.

23. The method of claim 15 wherein said parameter estimation system uses a neural network algorithm, a hybrid neural network algorithm or self-organizing map.

24. The method of claim 15 wherein said model scoring system uses a subset of data not used in said calibration step.

25. The method of claim 15 wherein said model scoring system includes a penalty for model complexity.

26. The method of claim 15 wherein said model scoring system uses the Chi-square test, the Kolmogorov-Smirnoff test or the Anderson-Darling test.

27. The method of claim 15 wherein said model scoring system uses the Akaike Information Criterion.

28. The method of claim 15 wherein said model scoring system uses a non-parametric statistical test.

29. A method for automated hypothesis testing, said method comprising the steps of:
a. generating or selecting a plurality of computer simulation models of a biological or physiological system;
b. calibrating said plurality of models; and
c. comparing or ranking said plurality of models based upon the goodness of fit of each model to experimental data.

30. The method of claim 29 further comprising the step of modifying at least one of the plurality of models generated or selected in step a.

31. The method of claim 29 wherein the step of generating or selecting said plurality of models includes use of an expert system or machine learning algorithm.

32. The method of claim 29 wherein said calibration step is based at least in part on information about the experimental protocols used to generate the experimental data used in the calibration step or any earlier steps.

33. The method of claim 29 wherein said calibration step uses a batch estimator or recursive filter.

34. The method of claim 33 wherein said batch estimator is selected from the group consisting of the Levenberg-Marquardt method, the Nelder-Mead method, the steepest descent method, Newton's method, and the inverse Hessian method.

35. The method of claim 33 wherein said recursive filter is selected from the group consisting of the least-squares filter, the pseudo-inverse filter, the square-root filter, the Kalman filter and Jazwinski's adaptive filter.

36. The method of claim 29 wherein said calibration step uses a neural network algorithm, a hybrid neural network algorithm or self-organizing map.

37. The method of claim 29 wherein said comparison or ranking step uses a subset of data not used in said calibration step.

38. The method of claim 29 wherein said comparison or ranking step includes a penalty for model complexity.

39. The method of claim 29 wherein said comparison or ranking step uses the Chi-square test, the Kolmogorov-Smirnoff test or the Anderson-Darling test.

40. The method of claim 29 wherein said comparison or ranking step uses the Akaike Information Criterion.

41. The method of claim 29 wherein said comparison or ranking step uses a non-parametric statistical test.

42. A system for automated hypothesis testing, said system comprising the steps of:
a. a hypothesis generation system for generating or selecting a plurality of computer simulation models of a biological or physiological system;
b. a parameter estimation system for calibrating said plurality of models; and
c. a model scoring system for comparing or ranking said plurality of models based upon the goodness of fit of each model to experimental data.

43. The system of claim 42 wherein said hypothesis generation system modifies at least one of said plurality of models generated or selected by said hypothesis generation system.

44. The system of claim 42 wherein said hypothesis generation system uses an expert system or machine learning algorithm.

45. The system of claim 42 wherein said parameter estimation system utilizes information about the experimental protocols used to generate the experimental data used in the calibration step or any earlier steps.

46. The method of claim 42 wherein said parameter estimation system uses a batch estimator or recursive filter.

47. The method of claim 46 wherein said batch estimator is selected from the group consisting of the Levenberg-Marquardt method, the Nelder-Mead method, the steepest descent method, Newton's method, and the inverse Hessian method.

48. The method of claim 46 wherein said recursive filter is selected from the group consisting of the least-squares filter, the pseudo-inverse filter, the square-root filter, the Kalman filter and Jazwinski's adaptive filter.

49. The method of claim 42 wherein said parameter estimation system uses a neural network algorithm, a hybrid neural network algorithm or self-organizing map.

50. The method of claim 42 wherein said model scoring system uses a subset of data not used in said calibration step.

51. The method of claim 42 wherein said model scoring system includes a penalty for model complexity.

52. The method of claim 42 wherein said model scoring system uses the Chi-square test, the Kolmogorov-Smirnoff test or the Anderson-Darling test.

53. The method of claim 42 wherein said model scoring system uses the Akaike Information Criterion.

54. The method of claim 42 wherein said model scoring system uses a non-parametric statistical test.
